(19) United States
(12) Patent Application Publication
(10) Pub. No.: US 2008/0262660 A1
(43) Pub. Date: Oct. 23, 2008

(54) Control-Information System For Mass Transportation Vehicles

(76) Inventors: Shmuel Weber, Jerusalem (IL); Shlomp Weber, Mevasseret Zion (IL); Hillel Weber, Jerusalem (IL)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/088,085

(22) PCT Filed: Dec. 26, 2005
(86) PCT No.: PCT/IL05/01375

§ 371 Date: Mar. 25, 2008

(30) Foreign Application Priority Data
Sep. 28, 2005 (IL) 171154

(51) Int. Cl. G06F 19/00

(52) U.S. Cl. 701/1

(57) ABSTRACT

A control-information system for mass transportation vehicles intended for transmitting to passengers of mass transportation vehicles while on the road, any kind of information corresponding to the defined spot on the route. The control-information system includes: —an information center; —the proxy using a high-frequency band for receiving the new multimedia data or any other “big” files from the information center and for sending this data from the proxy to the data end points; —a management unit, which can control the data end points and the information center; —a plurality of data end points, which are housed in each mass transportation vehicle, including in said system, involves: —a GPS receiver for receiving GPS signals, —a narrow-band unit for communication between the data end point and the information center, —a wide-band unit for communication between the data end point and the proxy, —a software unit, which is based on data of location and time, decides when and which data will be shown on the display-monitor.

### FIELD OF THE INVENTION

This invention generally relates to information systems for vehicles (road transportation, urban transportation, railway transportation) including a central station (host) with database, and a plurality of data end points, one data end point on each vehicle; and in particular to a system intended for transmitting to the data end points various kinds of data consumed by the passengers. Each data end point has a receiver for receiving signals from a Global Positional System (GPS), and operates according to these GPS signals, based on at least 3 satellites.

### BACKGROUND OF THE INVENTION

There are many patents concerning usage of GPS receivers on vehicles. Global Positional System (GPS) is a space-based radio-positioning and time transfer system. GPS provides accurate position, velocity, and time (PVT) information for the data end points in a vehicles, anywhere on the face of earth it is. GPS has at least 3 satellites, each of which broadcasting radio frequency (RF) ranging codes and navigation data messages. Each navigation data message includes such data as satellite clock-bias data, ephemeris data (precise orbital data of the satellite), central correction data, and satellite almanac data (coarse orbital data on all satellites).

In U.S. Pat. No. Re 038781 (Aug. 23, 2005) there is disclosed a vehicle data processing system which can communicate with an information center. This system has vehicle data end points and an information center. The vehicle data end point includes an on-vehicle data processor and an off-vehicle input unit, independently located in the operator's home or another place. The data processor has a data receiving portion and a data transmitter for transmitting a start signal to the information center. The information center includes a data storage unit, a sensor unit, and a data transmitter.

In U.S. Pat. No. 6,922,138 (Jul. 26, 2005) there is disclosed a vehicle specific messaging apparatus and method. This system is intended for providing directed advertising or information messages specific to individual persons or vehicles, or for providing unsolicited advertising or information messages to one or more occupants of anonymous vehicles. The system encompasses a sensing and evaluation mechanism to detect persons or vehicles, in conjunction with a billboard or other display device capable of delivering a specific message to one or more individuals.

In U.S. Pat. No. 6,889,139 (May 3, 2005) there is disclosed a system and method for mobile data processing and transmission. The system includes an interface unit with a processor, a positioning subsystem coupling to a first antenna and to the processor, and a remote data end point electrically coupled to the interface unit.

Most of the known systems and methods for mobile data processing and transmission, including said three U.S. patents, have at least one data end point, the information center (host) and transmission of data from the information center to data end points. All known systems and methods for mobile data processing and transmission have only one canal for transmission of all kinds of data.

Communication between vehicle data end points and the information center, and data transmission are very slow (less than 10 kb per sec). That is a problem. In the present invention this problem is solved by including in the system a middleman unit (proxy) between the information center and the data end points. The difference between types of data and transmitting them by different canals, allow greatly to increase the speed of transmission and achieve transmission speed of more then 100 mb per second.

If in the systems and methods for mobile data processing and transmission a middleman unit (proxy) is not used between the information center and the data end point, it is almost impossible to transmit large scale data on-line.

### SUMMARY OF THE INVENTION

A control-information system for mass transportation vehicles includes:
an information center or server, including:
   a database and data management unit,
   a narrow-band unit for communication between the information center and data end points;
   a wide-band unit for communication between the information center and a proxy;
the proxy using a high-frequency band (wide band) for receiving the new multimedia data or any other “big” files from the information center and for sending this data from the proxy to the data end points;
a management unit, which can control the data end points and the information center;
a plurality of data end points, housed in each mass transportation vehicle, included in the said system, involves:
   a GPS receiver for receiving GPS signals,
   a narrow-band unit for communication between the data end point and the information center,
   a wide-band unit for communication between the data end point and the proxy,
   a software unit, which is based on GPS data of location and time, and decides when and which data will be shown on a display-monitor;
   a display-monitor.

The database and data management unit of the information center holds all data which is being used for the control-information system, and handles all data exchange between the proxy and the data end points, the database and data management unit include information about each mass transportation vehicle, each traffic station, every shop and restaurant nearby the stations on the way, details of contracts with clients, and other various kinds of information.

### BRIEF DESCRIPTION OF THE DRAWINGS

This invention is described by several illustrations:

FIG. 1 is a schematic system diagram of the control-information system (1) according to the present invention illustrating the principal system elements.

FIG. 2 is a block diagram of the control-information system (1) according to the present invention illustrating the operation connections between elements

### DETAILED DESCRIPTION OF THE INVENTION

A control-information system (1) according to the present invention intended for transmitting to passengers of mass transportation vehicles (6) while on the road, any kind of information corresponding to the defined spot on the route, for example information regarding interesting places on the way; history of central monuments; and advertisement of shops and restaurants near the stations on the way.

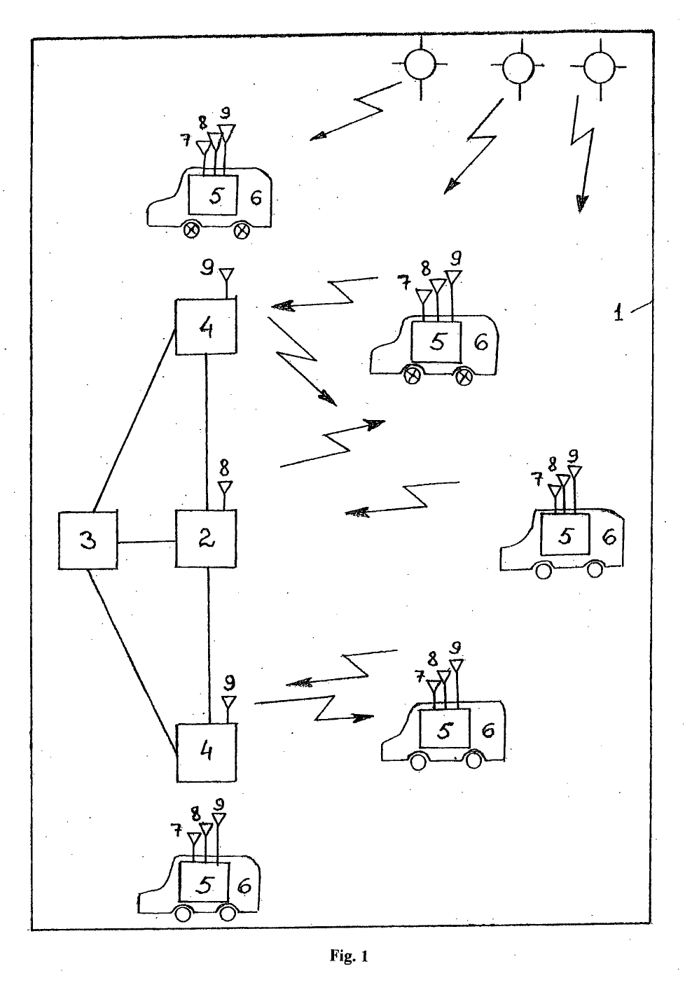

The control-information system (1) for mass transportation vehicles (6) according to the present invention is shown on FIG. 1 and includes:
an information center or server (2) for serving and collecting data for data end points (5);
a manager unit (3) used for managing the control-information system (1): entering, changing companies, contracts, medias, locations, news and settings, and also can control the information center (2) or data end points (5);
a proxy (4),
a plurality of data end points (5), while on each mass transportation vehicle (6) included in the control-information system (1), there is only one data end point (5).

In the preferred version of the control-information system (1), commercials are being displayed in mass transportation vehicles (6) on the roads, railway or railway stations, corresponding a defined spot. Transmitting advertisements, for example for shops and restaurants nearby the stations on the way, or advertisements regarding specific goods, must be shown at the right moment of time and in the specific place. Transmitting advertisements to passengers of mass transportation vehicles (6) by the data end points (5) in this mass transportation vehicles (6) should be done only if time, local position and text of the advertisement are matching. The data end point (5) is a unit determining when time, local position and text of the advertisement are matching and when the advertisement will be transmitted.

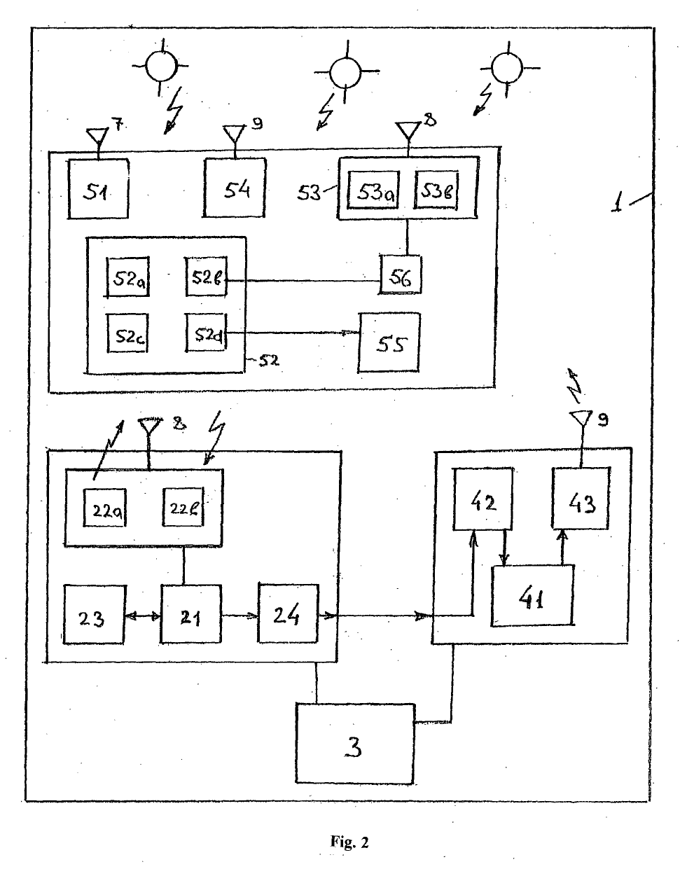

The control-information system (1) for mass transportation vehicles (6) according to the present invention is shown on FIG. 2 and includes subunits of the said main parts of the system (1).

Each data end point (5) has a GPS receiver (51) and an antenna (7) for receiving GPS signals, a software unit (52), a narrow-band unit (53) for communication between the data end point (5) and the information center (2), a wide-band unit (54) for communication between the data end point (5) and the proxy (4), a display-monitor (55), a cellulary modem (56) and a wireless network antenna (8).

The location data from the GPS receiver (51) defines the longitude and the latitude of the position of mass transportation vehicles (6).

The software unit (52) includes the following subunits:
a database (52a),
a communicational manager (52b), which is responsible for communication with the information center or server (2) and with the proxy (4),
a data manager (52c), which is responsible for data storage,
a show-play manager (52d), which controls playing commercials and includes a commercial timer, which is used for defining the commercial unit length (interval).

Each data end point has a two-directional communication: it receives and sends data. All kinds of data arrives at the software unit (52) on database (52a). The software unit (52), based on data of location and time, decides:
when the narrow-band unit (53) will communicate with the information center (2),
when the wide-band unit (54) will communicate with the proxy (4),
when and which data to show on the display-monitor (55).

There are few reasons why the data end point (5) requests the data:
only the data end point (5) “knows” when and where it needs specific data and then requests this data by a cellular device (53);
the data end point (5) is an available during 24 hours, 7 days a week (100% of the time);
this is the best way to divide the hand-shake issue to the date end points; the hand-shake process is relatively a long process in computer communication (can last a few seconds).

The narrow-band unit (53) on the data end point (5) is a cellular device, connected to a cellular modem (56). This cellular device (53) includes a transmitter (53a) for transmitting data regarding GPS signals and requests to the information center (2), and a receiver (53b) for receiving news and details of contracts with clients from the information center (2).

The wide-band unit (54) of the data end point (5) is a wireless canal receiver for receiving movie data from the proxy (4) with a wireless network antenna (8).

Workflow in the data end point (5) is as follows:
getting current time and location data from the GPS receiver (51),
checking the next item to show on the display-monitor (55) according to location, time and requested broadcast frequency,
sending data to the screen of the display-monitor (55),
after the end of show on the display-monitor (55), returning to get current time and location data from the GPS receiver (51).

Communication between the data end point (5) and the information center (2) is created by the communicational manager (52b) of the data end point (5) for each time quota and includes:
sending data of location,
receiving data of current contracts,
receiving news.

The information center or server (2) has a database and a data management unit (21), a narrow-band unit (22) for communication between the information center (2) and the data end point (5), a cellular modem (23), and a wide-band unit (24) for communication between the information center (2) and the proxy (4).

The database and data management unit (21) of the information center (2) holds all data which is being used for the control-information system (1). The information center (2) handles all data exchange between the proxy (4) and the data end points (5). The database and data management unit (21) include information regarding each mass transportation vehicle (6), each traffic station, every shop and restaurant nearby the stations on the way, details of contracts with clients, and other various kinds of information. All changes to this database and data management unit (21) are being done using stored procedures.

The narrow-band unit (22) on the information center (2) is a cellular device, connected to a cellulary modem (23). This cellular device (22) include a transmitter (22a) for transmitting data of news and details of contracts with clients from the information center (2) to the data end point (5), and a receiver (22b) for receiving data regarding GPS signals to the information center (2) from the data end point (5).

The workflow in the information center (2) is as follows:
defining company-client,
defining company's medias,
defining locations of the data end point (5),
defining company's contracts,
defining relevant media,
defining relevant points,
defining requested frequency,
preparing for usage.

The management unit (3) has 3 main parts:
a visible part (forms, panels) —objects visible to the user,
a data transformation part, which prepares data transferred from or to the information center (2),
data exchange and a setting part, which communicates with the information center (2).

The management unit (3) has data information regarding companies-clients, contracts, medias, locations, and can also control the data end points (5) and the information center (2). The user can add a company, a contract with this company, media of a commercial for this company, and also select a location where this commercial should be shown.

The user is a skilled technician that needs to update all the technical data of the control-information system (1): configuration of the information center (2), details of the proxies (4), details of the data end points (5) and maintain the commercial data. The user is responsible to the maintenance of the term-system manager.

There are two types of data transferred from the information center (2) to the data end point (5):
the first type—is textual data, for example news, measured in hundreds of bytes (up to 1 k bytes or a few kb); this type of data is sent directly from the information center (2) to the data end point (5);
the second type is multimedia data or any other “big” files such as big text files and/or applications measured in many kb (up to 100 mb); this type of data will be transmitted throughout an intermediate unit—a middleman between the information center (2) and the data end point (5); if this type of data will be sent directly from the information center (2) to the data end point (5), it, will cause a bottle-neck when more then one of the data end points (5) will try to receive data.

To eliminate the said appearance of a bottle-neck, the control-information system (1) according to the present invention includes the proxy (4). For receiving the new multimedia data or any other “big” files from the information center (2) to the proxy (4), a high-frequency band (wide band) is being used by a wire line canal, and for sending this data from the proxy (4) to the data end point (5), a wide-band of a wireless canal is being used.

Actually, the proxy (4) behaves as a warehouse storing data from the information center (2) for usage by the data end points (5).

When certain data in the information center (2) is ready, communication is created with the proxy (4) and data is being sent to the proxy (4). The difference between types of data and transmitting them by different canals, allow greatly to increase transmission speed and achieves transmitting more then 100 mb per second.

The proxy (4) has a data storage unit (41), a wide-band receiver (42) for communication between the proxy (4) and the information center (2), and a wide-band transmitter (43) for communication between the proxy (4) and the data end point (5).

The wide-band receiver (42) is inside a wire canal, connecting the proxy (4) with the information center (2). Communication between the proxy (4) and the information center (2) is created by the information center (2) when certain data is ready and that data is sent to the proxy (4). The connection between the information center (2) and the proxy (4) can be any wide band alternative, for example it can be satellite communication.

The wide-band transmitter (43) is inside a wireless canal with an antenna (9). Communication between the proxy (4) and the data end point (5) is created by the data end point (5), and the wireless canal operates only when the vehicle (6) with the data end point (5) comes near the proxy (4), for example in the central bus station. During this communication the data end points (5) receive new medias from the proxy (4) and activate contracts related to these medias.

A control-information system (1) according to the present invention consists of:
a information center (2), including:
   a data management and storage unit (21),
   a narrow-band unit (22) for communication between the information center (2) and the data end point (5); the narrow-band unit (22) is a cellular device, connected to a cellular modem (23); this cellular device (22) includes a transmitter (22a) for transmitting data of news and details of contracts with clients from the information center (2) to the data end point (5), and a receiver (22b) for receiving data about GPS signals to the information center (2) from the data end point (5);
   a cellular modem (23),
   a wide-band unit (24) for communication between the information center (2) and the proxy (4);
the management unit (3) has data information regarding companies-clients, contracts, medias, locations, and can also control the data end points (5) and the information center (2) and has 3 main parts:
   a visible part (forms, panels) —objects visible to the user,
   a data transformation part—a unit which prepares data transferred from or to the information center (2),
   a data exchange and setting part—this unit is communicating with the information center (2),
a proxy (4) having
   a data storage unit (41),
   a wide-band receiver (42) for communication between the proxy (4) and the information center (2), while the wide-band receiver (42) is inside a wire canal,
   a wide-band transmitter (43) for communication between the proxy (4) and the data end point (5); while the wide-band transmitter (43) is inside a wireless canal with an antenna (9), which operates only when the vehicle with the data end point (5) comes near the proxy (4), for example in the central bus station; for receiving by the proxy (4) the new multimedia data or any other “big” files from the information center (2) using a high-frequency band (wide band) of a wire line canal, for sending this data from the proxy (4) to the data end point (5) using a wide-band of a wireless canal; actually, the proxy (4) behaves as a warehouse storing data from information center (2) for usage by the data end points (5);
at least one data end point (5), which is housed in each mass transportation vehicle (6), including in the said system (1), involves:
   GPS receiver (51) with an antenna (7) for receiving GPS signals,
   a software unit (52), when all kinds of data arrives at the software unit (52), the software unit (52), based on data of location and time, decides:
      when the narrow-band unit (53) will communicate with the central station (2),
      when the wide-band unit (54) will communicate with the proxy (4),
      when and which data to show on the display-monitor (55);
   a narrow-band unit (53) with an antenna (8) for communication between the data end point (5) and the information center (2); the narrow-band unit (53) is a cellular device, connected to a cellular modem (56); this cellular device (53) includes a transmitter (53a) for transmitting data regarding GPS signals to the information center (2), and a receiver (53b) for receiving news and details of contracts with clients from the information center (2);
   a wide-band unit (54) with an antenna (9) for communication between the data end point (5) and the proxy (4); while the wide-band unit (54) is a wireless canal receiver for receiving movie data from the proxy (4) with a wireless network antenna (9);
   a display-monitor (55),
   a cellular modem (56),
   a wireless network antenna (9).

A method of information passengers of the mass transportation vehicles (6) according to the present invention in specific hours and in a specific section of the way includes:
requesting by a data end point (5) from GPS and receiving location information (GPS signals) from several satellites,
requesting by the data end point (5) from the information center (2) and receiving textual data (data of news and details of contracts with clients) by a cellular canal;
transmitting data of multimedia or any other “big” files such as big text files and/or applications needed to be transferred from the information center (2) to the data end point (5) throughout an intermediate unit—proxy (4); the proxy (4) receiving the large scale files from the information center (2) by a wire line canal in a high-frequency band (wide band), and sending this data from the proxy (4) to the data end points (5) in a wide-band of a wireless canal;
show on the display-monitor (55) of the data end point (5) desired data, when the software unit (52), based on data of location and time, decides when and which data needs to be show on the display-monitor (55); that decision is made when the location data from the GPS receiver (51) corresponds to conditions of the contract with a concrete client in the database (52a) of the software unit (52).

In the preferred variation of the said method, data needed to be shown on the display-monitor (55), is advertisement of shops and restaurants near the stations on the way of the mass transportation vehicles (6).

A method intended for transmitting to passengers of mass transportation vehicles (6) on the road any kind of information corresponding to a defined spot, for example information regarding interesting places or points on the way; history of certain monuments; and advertisement for stores and restaurants nearby the stations on the way, in a specific time and place, consists:
storing information regarding details of contracts with clients (advertisement companies);
receiving information regarding the local position of the mass transportation vehicles (6);
deciding when the time according to a specific contract, data of the local position of said mass transportation vehicles (6) according to a specific contract, and data of advertisement text, coincides.

1. A control-information system for mass transportation vehicles includes:
an information center or server, including:
a database and data management unit,
a narrow-band unit for communication between an information center and data end points;
a wide-band unit for communication between the information center and a proxy;
the proxy using a high-frequency band (wide band) for receiving the new multimedia data or any other “big” files from the information center and for sending this data from the proxy to the data end points;
a management unit, which can control the data end points and the information center;
a plurality of data end points, which are housed in each mass transportation vehicle, including in said system, involves:
a GPS receiver for receiving GPS signals,
a narrow-band unit for communication between the data end point and the information center,
a wide-band unit for communication between the data end point and the proxy,
a software unit, which is based on data of location and time, decides when and which data will be shown on the display-monitor;
a display-monitor.

2. A control-information system for mass transportation vehicles according to claim 1, wherein said database and data management unit of the information center holds all data which is being used for the control-information system and handles all data exchange between the proxy and the data end points; the database and data management unit include information regarding each mass transportation vehicle, each traffic station, every shop and restaurant nearby the stations on the way, details of contracts with clients, and other various kinds of information.

3. A control-information system for mass transportation vehicles according to claim 1, wherein the said narrow-band unit of the information center is a cellular device, connected to a cellular modem; this cellular device includes a transmitter for transmitting data of news and details of contracts with clients from the information center to the data end points, and a receiver for receiving data regarding GPS signals and requests coming to the information center from the data end point.

4. A control-information system for mass transportation vehicles according to claim 1, wherein the said narrow-band unit of the data end points is a cellular device, connected to a cellular modem; this cellular device includes a transmitter for transmitting data regarding GPS signals and requests coming to the information center, and a receiver for receiving news and details of contracts with clients from the information center.

5. A control-information system for mass transportation vehicles according to claim 1, wherein the said wide-band unit of the data end points is a wireless canal receiver with a wireless network antenna for receiving movie data from the proxy.

6. A control-information system for mass transportation vehicles according to claim 1, wherein the said software unit of the data end points includes the following subunits:
a database,
a communicational manager, which is responsible for communication with the information center and with the proxy,
a data manager, which is responsible for data storage,
a show-play manager, which controls playing commercials and includes a commercial timer, which is used for defining the commercial unit length (interval).

7. A control-information system for mass transportation vehicles according to claim 1, wherein the said proxy is an intermediate unit—a middleman between the information center and the data end point; actually, the proxy behaves as a warehouse storing data from the information center for usage by the data end points; for receiving the new multimedia data or any other “big” files from the information center to the proxy using a high-frequency band (wide band) of a wire line canal, and for sending this data from the proxy to the data end points using a wide-band of a wireless canal.

8. A control-information system for mass transportation vehicles according to claim 1, wherein the said proxy has the following parts:
a data storage unit,
a wide-band receiver for communication between the proxy and the information center, and
a wide-band transmitter for communication between the proxy and the data end points.

9. A control-information system for mass transportation vehicles according to claim 8, wherein the said wide-band receiver is included in a wire canal, connecting the proxy with the information center.

10. A control-information system for mass transportation vehicles according to claim 8, wherein the said connection between the information center and the proxy is any wide band alternative, for example it can be satellite communication.

11. A control-information system for mass transportation vehicles according to claim 8, wherein the said wide-band transmitter of the proxy has an antenna and is included in a wireless canal; this wireless canal operates only when the vehicle with the data end point will be near the proxy, for example in the central bus station.

12. A control-information system for mass transportation vehicles according to claim 1, wherein the said management unit can control the data end points and the information center, and has 3 main parts:
a visible part (forms, panels) —objects visible to the user,
a data transformation part, which prepares data transferred from or to the information center,
data exchange and a setting part, which are communicating with the information center.

13. A method of information passengers of the mass transportation vehicles according to claim 1, includes:
storing information regarding details of contracts with clients (advertisement companies);
receiving information regarding the local position of the mass transportation vehicles;
deciding when the time, data of the local position of the said mass transportation vehicles according to a specific contract, and data of advertisement text, coincides.
show on the display-monitor of the data end point of desired data.

14. A method of information passengers of the mass transportation vehicles according to claim 13, includes:
requesting by the data end points of data from GPS and receiving location information (GPS signals) from several satellites;
requesting by the data end points of data from the information center and receiving textual data (data of news and details of contracts with clients) by a cellular canal;
transmitting textual data from the information center to the data end points directly by the cellular (narrow-band) canal;
transmitting data of multimedia or any other “big” files from the information center to the data end points throughout an intermediate unit—the proxy; the proxy is receiving the new large scale files from the information center by a wire line canal in a high-frequency band (wide band) and sends this data from the proxy to the data end points in a wide-band of a wireless canal;
show on the display-monitor of the data end point of desired data, when the software unit, based on data of location and time, decides when and which data needs to be shown on the display-monitor; this decision is made when the location data from the GPS receiver corresponds to conditions of the contract with a concrete client in the database of the software unit.

15. A method of information passengers of the mass transportation vehicles according to claim 14, wherein the reasons why the data end points requests the data is:
only the data end point “knows” when and where it needs specific data and then requests this data by a cellular device;
the data end point is available during 24 hours, 7 days a week (100% of the time);
this is the best way to divide the hand-shake issue to the date end points; the hand-shake process is relatively a long process in computer communication (can last a few seconds).

16. A method of information passengers of the mass transportation vehicles according to claim 13, wherein the workflow in the data end points is as follows:
getting current time and location data from the GPS receiver,
checking the next item to show on the display-monitor according to location, time and requested broadcast frequency,
sending data to the screen of the display-monitor,
returning to getting current time and location data from GPS receiver after end of show on the display-monitor.

17. A method of information passengers of the mass transportation vehicles according to claim 13, wherein the workflow in the information center is as follows:
defining company-client,
defining company's medias,
defining locations of the data end points,
defining company's contracts,
defining relevant media,
defining relevant points,
defining requested frequency,
preparing for usage.

18. A method of information passengers of the mass transportation vehicles according to claim 13, wherein said data information is transferred from the information center to the data end points divided to two different types, which are transferred by different canals:
the first type is textual data, for example news, measured in hundreds of bytes (up to 1 k bytes or a few kb); this type of data is sent directly from the information center to the data end points;
the second type is multimedia data or any other “big” files such as big text files and/or applications measured in many kb (up to 100 mb); this type of data will be transmitted throughout an intermediate unit—a middleman between the information center and the data end point.

19. A method of information passengers of the mass transportation vehicles according to claim 15, wherein the said partition of different types of data and transmitting them by different canals, allow to increase greatly transmission speed, and achieves transmitting speed of more then 100 mb per second.

20. A method of information passengers of the mass transportation vehicles according to claim 13, wherein communication between the data end point and the information center is created by the communicational manager of the data end point each time quota, and includes:
sending data of location,
receiving data of current contracts,
receiving news.

21. A method of information passengers of the mass transportation vehicles according to claim 13, wherein communication between the information center and the proxy is created all the time whenever certain data in the information center is ready.

22. A method of information passengers of the mass transportation vehicles according to claim 13, wherein the user is a skilled technician that needs to update all the technical data of the control-information system: configuration of the information center, details of the proxies, details of the data end points, and maintain the commercial data; the user is responsible to the maintenance of the term-system manager.
